(19) United States
(12) Patent Application Publication
(10) Pub. No.: US 2019/0330042 A1
(43) Pub. Date: Oct. 31, 2019

(54) SYSTEM AND METHOD FOR DISPENSING PRODUCTS

(71) Applicant: Walmart Apollo, LLC, Bentonville, AR (US)

(72) Inventors: Benjamin D. ENSSLE, Bella Vista, AR (US); Shaun R. RORRISON, Bentonville, AR (US); Ross A. MCKINNON, Rogers, AR (US); David B. BRIGHTWELL, Bentonville, AR (US)

(73) Assignee: Walmart Apollo, LLC, Bentonville, AR (US)

(21) Appl. No.: 16/397,253

(22) Filed: Apr. 29, 2019

Related U.S. Application Data
(60) Provisional application No. 62/663,598, filed on Apr. 27, 2018.

(51) Int. Cl. B67D 1/00; G07F 13/06; G07F 13/04; B67D 1/08; B67D 1/12

(52) U.S. Cl. CPC B67D 1/0015; G07F 13/065; G07F 13/04; B67D 1/1279; B67D 1/1206; B67D 1/1227; B67D 1/0878

(57) ABSTRACT

Systems and methods for dispensing a product from a dispensing kiosk are provided. An example system can include: a first tank at a first location, and storing skim milk and connected to a first conduit; a second tank at the first location, and storing milk fat and connected to a second conduit; and a dispensing kiosk at a second location remote from the first location, the dispensing kiosk comprising: a terminal receiving a request, the request including a type and an amount of a product for purchase; a dispensing station adapted to receive a container, the dispensing station comprising a filling tube extended into the container for providing the product into the container based on the type and the amount in the request; a scanner adapted to read a machine-readable code on the container placed in the dispensing station; and a labeling mechanism configured to print and apply a label to the container in the dispensing station, the label including at least one of the type, the amount, a price, and a fill date of the product.

### CROSS REFERENCE TO RELATED APPLICATION

This patent application claims the benefit of U.S. Provisional Application No. 62/663,598, filed on Apr. 27, 2018, content of which is incorporated by reference herein.

### BACKGROUND

### 1. Technical Field

The present disclosure relates to systems and methods for dispensing products at a dispensing kiosk.

### 2. Introduction

A wide variety of milk or popular frozen foods are normally stocked in refrigerators or freezers in a merchant's store. These products may be in stock for a long time before purchase by customers. Customers prefer fresh milk and fresh frozen foods. Customers may also want to customize their products with different flavorings (e.g., chocolate, vanilla, etc.) and percentages of milk (e.g., skim, 1%, 2%, etc.) For example, various types of fresh milk may be needed for babies, younger children, or adults based on their particular needs. Fresh frozen foods, such as ice creams with different flavors, are also very popular. Existing machines for dispensing milk and frozen foods may be found in some restaurants or small stores, which are normally standalone systems and do not communicate with networks. Therefore, there is a need for a dispensing system which may not only offer customers a variety of products but may also customize the products onsite in the merchant's store based on the customer's preferences.

### SUMMARY

An example system configured for dispensing products from a dispensing kiosk according to the concepts and principles disclosed herein can include: a first tank at a first location, and storing skim milk and connected to a first conduit; a second tank at the first location, and storing milk fat and connected to a second conduit; and a dispensing kiosk at a second location remote from the first location, the dispensing kiosk comprising: a terminal receiving a request, the request including a type and an amount of a product for purchase; a dispensing station adapted to receive a container, the dispensing station comprising a filling tube extended into the container for providing the product into the container based on the type and the amount in the request; a scanner adapted to read a machine-readable code on the container placed in the dispensing station; and a labeling mechanism configured to print and apply a label to the container in the dispensing station, the label including at least one of the type, the amount, a price, and a fill date of the product.

An example method of performing concepts disclosed herein can include: receiving, by a dispensing kiosk, a request including an amount and a type of a product for purchase; scanning, by a scanner, a machine-readable code on a container placed in a dispensing station of the dispensing kiosk; providing, by the dispensing station, the product into the container through a filling tube extended into the container based on the amount and the type in the request; and printing and applying, by a labeling mechanism, a label to the container, the label including at least one of the type, the amount, a price, and a fill date of the product.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Example embodiments of this disclosure are illustrated by way of an example and not limited in the figures of the accompanying drawings, in which like references indicate similar elements and in which:

FIG. 1 is a block diagram illustrating an example computing environment in which some example embodiments may be implemented;

FIG. 2 shows a diagram illustrating an example product dispensing system in accordance with some example embodiments;

FIG. 3 is a flowchart diagram illustrating a process for dispensing products at a dispensing kiosk in accordance with some example embodiments; and

FIG. 4 is a block diagram illustrating an example computer system in which some example embodiments may be implemented.

It is to be understood that both the foregoing description and the following detailed description are exemplary and explanatory and are intended to provide further explanations of the invention as claimed only and are, therefore, not intended to necessarily limit the scope of the disclosure.

### DETAILED DESCRIPTION

Various example embodiments of the present disclosure will be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

Systems and methods in this disclosure provide a dispensing kiosk to provide a fresh product and to price the product based on the customer's selections. For example, a dispensing kiosk can provide a customer a variety of fresh products, such as fresh milk, yogurt, ice cream, smoothies, etc. The customer may stop by the dispensing kiosk in person to select a particular product. The customer may also place an online order and select a dispensing kiosk for pickup of a completed order.

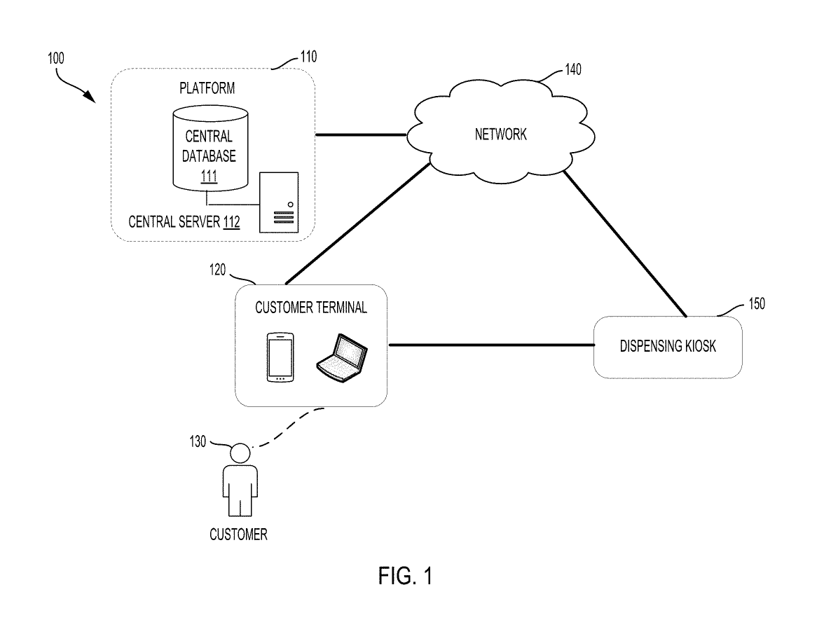

As shown in FIG. 1, a platform 110 may operate a merchant's website hosted on a web server (not shown). A plurality of dispensing kiosks 150 and one or more physical merchant stores may communicate with the platform 110 to sell one or more products and services. The dispensing kiosk 150 may be located in the merchant's physical stores or other locations convenient for customers to access.

In an example computing environment 100, the platform 110 may include one or more servers, shown and referred to as a central server 112 for simplicity, and one or more databases, shown and referred to as a central database 111 herein for simplicity. The central server 112 and central database 111 may be communicatively coupled to receive information and data from network devices via a network 140. The central server 112 may include one or more processors and be configured to allow customers to place and pick up an online order of one or more products at the dispensing kiosk 150 via the network 140. The central server 112 may also conduct payment transactions via traditional payment networks related to credit and check cards or via one or more mobile payment accounts linked with customer's credit card or debit card accounts.

A customer terminal 120 may represent a mobile device such as a smartphone, a tablet computer, a notebook computer, or a desktop computer that is communicatively coupled to the network 140 to allow a customer 130 to communicate, access information and place orders via the platform 110. The customer 130 may create, via the central server 112 and network 140, an account with the platform 110 to create a customer profile for storing personal information of the customer 130 in the central database 111. Each customer profile may be configured to store data related to the customer 130. The data may include customer's name, password, email address, mobile phone number, shipping address, customer's preferences, payment transaction accounts, purchasing preferences, search history, purchase history, pending orders, other relevant demographic or analytical data, third parties including family members, friends, or neighbors, etc. The customer 130 may also request, create or generate one or more tasks, transactions or records in the central database 111 with the platform 110 via the central server 112 using the customer terminal 120. A unique Quick Response (QR) code or other type of code may be generated for the customer 130 via the central server 112. The unique QR code may be read or accessed by computing devices (processors) in the dispensing kiosk for checking status of the customer's pending order or to request the dispensing kiosk to process a saved request.

The network 140 may include wired and wireless networks that enable communications between the various networked devices associated with the example computing environment 100, such as the customer terminal 120, the central server 112, and the dispensing kiosk 150.

The dispensing kiosk 150 may be configured to provide a variety of products, such as milk, yogurt, ice cream, smoothies, etc. The milk provided from the dispensing kiosk 150 may be skim milk, 1% milk, 2% milk, whole milk, chocolate milk, or a customized milk. Different sizes and types of containers may be provided for different volumes and types of products. The containers should include some standardized features, such as a neck and closure, to ensure proper filling and sealing. The dispensing kiosk 150 may also accept or recycle containers returned by the customers in order to decrease a number of disposable containers.

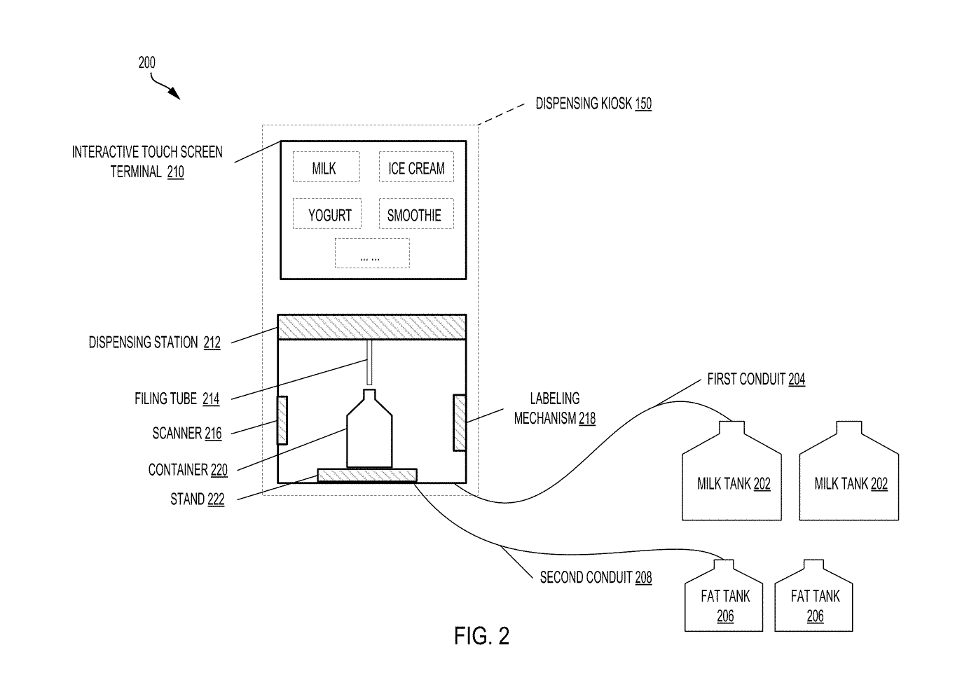

FIG. 2 is a block diagram illustrating an example product dispensing system 200 in accordance with some example embodiments. The example product dispensing system 200 is one of several example embodiments based on example computing environment 100, and is provided solely for illustrative purpose, so that those skilled in the art may better appreciate benefits and advantages provided by the present disclosure. Therefore, the scope of the present disclosure is not limited to the example product dispensing system 200.

As illustrated in FIG. 2, the example product dispensing system 200 may include a dispensing kiosk 150, one or more milk tanks 202, a first conduit 204, one or more fat tanks 206, and a second conduit 208. The dispensing kiosk 150 may include a touch screen terminal 210, a dispensing station 212, a scanner 216, a labeling mechanism 218, a processor, and a memory (not shown).

In some example embodiments, the milk tank 202 and the fat tank 206 are provided to store milk and fat for dispensing and mixing a product at the dispensing station 212. The milk tank 202 and the fat tank 206 may be located in a back room or other location at a merchant's physical store. The first conduit 204, e.g. milk conduit or milk hose, may be connected to the milk tank 202 for supplying milk to the dispensing station 212 of the dispensing kiosk 150. The second conduit 208, e.g. fat conduit or fat hose, may be connected to the fat tank 206 for supplying fat to the dispensing station 212 of the dispensing kiosk 150. The first and second conduits 204, 208 may be coupled to a filling tube 214 of the dispensing station 212 via a regulator valve. The milk tanks 202 and fat tanks 206 may be sealed storage tanks delivered from dairy farms or the tanks may be refillable. The tanks may also be movable tanks and stocked in refrigerator areas in the back room of the merchant's store. The stocked milk and fat tanks may be placed and replaced in a First-in-First-out (FIFO) queue in a refrigerator area at a certain temperature as a merchant's inventory supply. Predefined procedures may be conducted to ensure milk and fat are fresh and constantly rotated such that the dispensing kiosk 150 may provide the fresh products.

T The interactive touch screen terminal 210 may be used to place an order at the dispensing kiosk 150. The interactive touch screen terminal 210 may include a touch screen user interface and a payment module including cash or cashless payment systems. The touch screen terminal 210 may be configured to receive the order for the product from the customer by communicating with the central server 112, the platform 110 and other computing devices via the network 140 or a wireless local area network (WLAN). The interactive touch screen terminal 210 may be also configured to read a confirmation code of a pending order, a QR code or other codes associated with the customer 130. The touch screen user interface may be a graphical user interface (GUI) for the customer 130 to select a type and a volume of one of a plurality of fresh products to fill a container. The customer 130 may customize the product the customer 130 wants using the touch screen user interface. A variety of products, flavors, and volumes may be displayed on the touch screen user interface for the customer 130 to select. For example, the customer 130 may select a type of product, such as fresh milk, yogurt, ice cream, or smoothie. The fresh milk may be one of skim milk, 1% milk, 2% milk, whole milk. The customer 130 may select flavorings for adding to the product using the touch screen user interface. The customer 130 may select one of a variety of volumes for the product, such as 1 gallon, ½ gallon, 1 pint, etc. The touch screen user interface may display a plurality of status of the dispensing station 212 such as the filling, the position of the container, and the size of the container.

The processor in the dispensing kiosk 150 may be configured to communicate with the interactive touch screen terminal 210, the dispensing station 212, the scanner 216, the labeling mechanism 218, and the customer terminal 120 as needed to execute one or more sets of instructions to implement the customer's requests. The memory may store the one or more sets of instructions executable by the processor as well as other data used by the processor.

The dispensing station 212 is configured for dispensing a variety of fresh products, such as fresh milk, yogurt, ice cream, or smoothie, etc. The product may be made by mixing at least one of ingredients comprising milk, fat, one bag of flavoring, water, ice, or other ingredients. For example, after the dispensing station 212 receives a request or a selection for a product with a type and a volume, the dispensing station 212 may be controlled by the processor to dispense a product based on the request or the selection of the product. The dispensing station 212 may include a filling tube 214, a stand 222, and a storage, such as a cabinet. The stand 222 may be configured to support the container 220. The filling tube 214 may be extended into the container 220 to fill the product. The cabinet may store a plurality of bags of flavorings for supplying different flavorings to the product. The flavorings may include chocolate flavor, vanilla flavor, strawberry flavor, banana flavor, or other flavors. Further, the dispensing station 212 may include various mechanical components to supply ingredients including cheese, cream, ice, or water for the product.

The dispensing station 212 may include a flow meter (not shown). The flow meter may be controlled by the processor to control the volume of the product filled in the container 220 based on the type and volume in the request for the product. In some example embodiments, the dispensing station 212 may include different types of sensors to ensure the product is filled into the container 220 properly. The dispensing station 212 may include a weight sensor which is configured to detect a weight of the container 220 including the product until the container 220 is filled to the corresponding weight for the requested volume. The weight sensor may be coupled to the stand 222. The dispensing station 212 may include a moisture sensor. The moisture sensor is configured to detect a moisture level around the container 220 and to monitor an overflow of the filling. The dispensing station 212 may include a door. The door may be closed after the container 220 is placed on the stand 222 and the dispensing station 212 starts a filling. The dispensing station 212 may include a sealing module configured to automatically seal the container 220 with a cap based on the type of the container 220 after the filling is completed. The sealing module may be disposed nearby the filing tube 214.

The dispensing station 212 may stock different sizes of containers 220 for the customer to choose. Each container 220 may have a machine-readable code printed on the surface of the container 220. The machine-readable code may represent a size and a type of the container 220.

Before the dispensing station 212 fills a product, the scanner 216 may scan or read the machine-readable code shown on the container 220 for the dispensing kiosk 150 to obtain the size and the type of the container 220. After the scanner 216 scans or reads a machine-readable bar code shown on the container 220, the customer 130 may put the scanned container on the stand 222 of the dispensing station 212. In one example embodiment, when the customer 130 arrives at the dispensing kiosk 150 and selects a product and a volume via the touch screen user interface, the dispensing kiosk 150 may automatically provide a container 220 based on the selection of the product and the scanner 216 may automatically scan or read a machine-readable code shown on the container 220.

After the dispensing station 212 completes filling the product, the labeling mechanism 218 may print and apply a label to a surface of the container 220. The contents printed on the label may provide product details and may indicate a product type, a product volume, a product price, and a product fill date, etc.

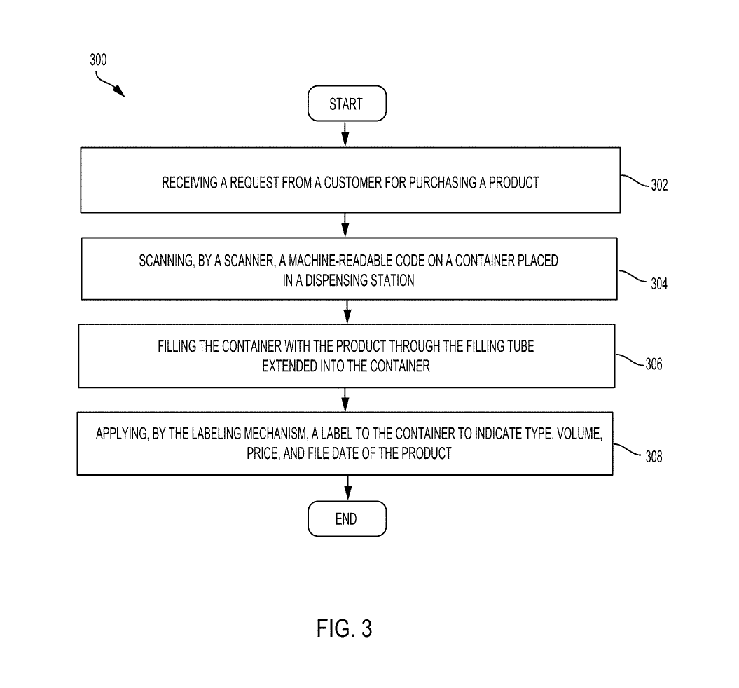

FIG. 3 is a flowchart diagram illustrating an example process 300 for dispensing a product based on a customer's request in accordance with some example embodiments. The process 300 may be implemented in the above described systems and may include the following steps.

In step 302, the dispensing kiosk 150 may receive a request from a customer 130 with a type and a volume for purchasing a product in various methods. For example, the customer 130 may place an online order, e.g., via the customer terminal 120, for one or more products. The customer 130 may select the dispensing kiosk 150 among a plurality of dispensing kiosks 150 associated with the merchant platform to pick up the online order. The website may provide a plurality of pickup timeslots for the customer 130 to choose and select. The online ordered product may be filled by the dispensing station 212 of the dispensing kiosk 150 and be placed in a refrigerator or freezer nearby or attached to the dispensing kiosk 150 with assistance from an employee of the merchant. In one example embodiment, the customer 130 may send the request for a product to the dispensing kiosk 150 via a merchant's application installed on the customer's mobile device. In one example embodiment, the customer 130 may use the merchant's application and generate a request with a recipe for filling a particular product at the dispensing kiosk 150. The customer 130 may send the recipe for the particular product to the dispensing kiosk 150 using the customer's mobile device 120 via near-field communication or Bluetooth. In one example embodiment, the customer 130 may arrive at the dispensing kiosk 150 and use the touch screen user interface to select the type and volume of a product. For example, the customer 130 may choose 1 gallon of 2% milk with one of the flavorings such as chocolate flavor, vanilla flavor, strawberry flavor, and banana flavor.

In step 304, the scanner 216 may scan or read a machine-readable code shown on the container 220 for the dispensing kiosk 150 to obtain a size of the container 220. For example, when the customer 130 arrives at the dispensing kiosk 150 and selects a product and volume via the touch screen user interface, the customer 130 may choose a container 220 stocked in the dispensing kiosk 150 based on the volume of the product the customer 130 wants. After the scanner 216 scans or reads a machine-readable bar code shown on the container 220, the customer 130 may put the scanned container on the stand 222 of the dispensing station 212. In one example embodiment, the dispensing kiosk 150 may automatically provide a container based on the selection. The container may also be scanned when placed on the stand 222.

In some example embodiments, before the dispensing station 212 fills the container 220 with the requested product, the size of the container 220 placed on a stand of the dispensing station may be verified by the processor based on a scanned information to ensure that the size of the container 220 matches the volume in the request for the product. The processor may verify whether the size of the container 220 matches the volume in the request before the container 220 is filled with the product. The touch screen user interface may show a message to indicate whether the size of the container 220 placed on the stand 222 matches the volume in the request for the product. The dispensing station 212 may fill the container 220 with the product only if the size of the container 220 matches the volume in the request for the product. The processor may further calculate the amount of milk, fat, flavoring or other ingredients required for the product and control the dispensing station 212 to make the required product.

In step 306, the dispensing station 212 may fill the container 220 with the requested product through the filling tube 214 extended into the container 220, based on the volume and the type in the request for the product, if the size of the container 220 matches the volume in the request for the product. The weight sensor of the dispensing station 212 may communicate with the processor and dynamically detect a weight of the container 220 on the stand 222 until the container 220 is filled to the volume in the request for the product. In one example embodiment, the moisture sensor in the dispensing station 212 may monitor an overflow of the filling by detecting a moisture level around the container 220. When a detected moisture level is not within a predefined moisture tolerance, the moisture sensor may send a signal to the processor to stop the filling of the product.

In step 308, once the dispensing kiosk 150 completes the filling of the requested product, a label may be printed out and applied to the surface of the container 220 by the labeling mechanism 218. The contents printed on the label may provide product details which may indicate a product type, a product volume, a product price, and a product fill date, etc.

In some example embodiments, the customer 130 may pay the product via the merchant application installed in customer's mobile device. For example, the customer 130 may scan the code of the filled container via the mobile application and pay for the product using a stored payment account. The merchant application may charge the customer's account associated with the mobile application for the filled product, and an electronic receipt may be sent to the customer 130 via a message and saved in the customer's account for review. If the product is filled based on an online order and the customer 130 may have already prepaid the order via the mobile application or via the merchant's website. The customer 130 may scan a received confirmation code in a product receipt and complete the payment transaction before taking the filled product away from the kiosk.

In some example embodiments, the customer 130 may check the availability of the products at the dispensing kiosk 150 via the website or the merchant's application associated with the platform. Whenever the dispensing kiosk 150 receives a request from the customer 130 for a product which is not available at that moment, the dispensing kiosk 150 may arrange the supplies for the requested product and inform the customer by sending a message, e.g. push notification or an e-mail to the customer's terminal when the product is available for ordering or pickup. For example, the customer 130 may drop by the dispensing kiosk or send a remote request via the merchant's application to fill one gallon of milk with a banana flavor and one gallon of milk with a strawberry flavor. The dispensing kiosk 150 may perform predefined calculations for amounts of ingredients required for the requested products. The dispensing kiosk 150 may arrange refills if the stocked ingredients are not enough for the kiosk 150 to dispense the requested products. When the requested products are available for ordering or pickup, the platform 110 may inform the customer 130 of an update by sending messages to the customer's mobile device.

In some example embodiments, the dispensing kiosk 150 may monitor and conduct quality and quantity control of the product inventory based on the sales record and the changes of the presented supplies in the dispensing kiosk 150. The milk, fat and all other ingredients in the dispensing kiosk 150 may be automatically monitored and restocked based on changes of the supplies and sales record in the dispensing kiosk 150 for maintaining a desired inventory.

In some example embodiments, the dispensing kiosk 150 may include cleaning components and predefined cleaning cycles to clean the conduits 204 and 208, the filling tube 214 and inside filling lines to ensure the dispensing kiosk 150 to dispense fresh products. The cleaning cycles may be performed when the milk tanks, fat tanks, or a cabinet for storing other ingredients are changed or refilled. The cleaning cycles may be short and quick processes preformed to clean out the product residues in the filling tube and inside filling lines between two fills to ensure the kiosk to dispense the fresh products.

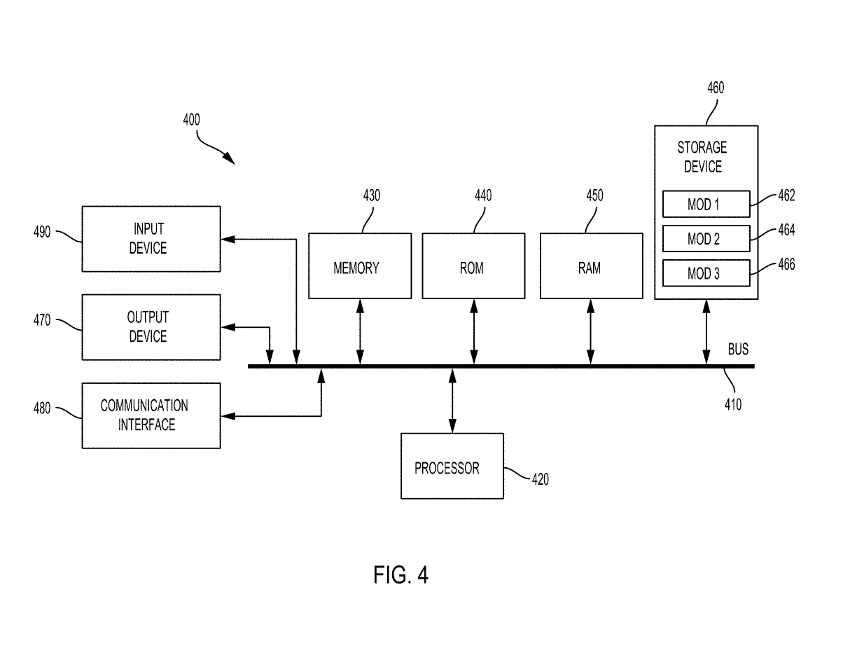

FIG. 4 illustrates an example computer system 400 which can be used to perform the processes for dispensing products at a dispensing kiosk as disclosed herein.

With reference to FIG. 4, an exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A product dispensing system, comprising:
a first tank at a first location, and storing skim milk and connected to a first conduit;
a second tank at the first location, and storing milk fat and connected to a second conduit; and
a dispensing kiosk at a second location remote from the first location, the dispensing kiosk comprising:
a terminal receiving a request, the request including a type and an amount of a product for purchase;
a dispensing station adapted to receive a container, the dispensing station comprising a filling tube extended into the container for providing the product into the container based on the type and the amount in the request;
a scanner adapted to read a machine-readable code on the container placed in the dispensing station; and
a labeling mechanism configured to print and apply a label to the container in the dispensing station, the label including at least one of the type, the amount, a price, and a fill date of the product.

2. The system of claim 1, further comprising a regulator valve coupled between the first conduit and the second conduit and the filling tube, the regulator valve controlling a mix of skim milk and milk fat to the filling tube to meet the request.

3. The system of claim 1, wherein the dispensing station further comprises:
a flow meter configured to control the amount of the product being filled into the container based on the request.

4. The system of claim 1, wherein the dispensing station further comprises:
a weight sensor configured to detect a weight of the container with the product until the container is filled to the amount in the request for the product.

5. The system of claim 1, wherein the product comprises one of milk, yogurt, ice cream, or smoothie.

6. The system of claim 1, wherein the dispensing kiosk further comprises a cabinet to store a plurality of flavorings for supplying one of the flavorings to the product, and wherein the flavorings comprise chocolate flavor, vanilla flavor, strawberry flavor, and banana flavor.

7. The system of claim 1, wherein the dispensing station is configured to dispense the product by mixing at least one of ingredients comprising milk, fat, one bag of flavoring, water, ice, or other ingredients.

8. The system of claim 1, wherein the dispensing station comprises a sealing module configured to automatically seal the container with a cap after the filling is completed.

9. The system of claim 1, wherein the terminal is configured to receive the request for the product and to display a plurality of status of the dispensing station on a touch screen user interface.

10. The system of claim 1, wherein the dispensing station comprises a moisture sensor in dispensing station which is configured to monitor an overflow of the filling of the container.

11. A method comprising:
receiving, by a dispensing kiosk, a request including an amount and a type of a product for purchase;
scanning, by a scanner, a machine-readable code on a container placed in a dispensing station of the dispensing kiosk;
providing, by the dispensing station, the product into the container through a filling tube extended into the container based on the amount and the type in the request; and
printing and applying, by a labeling mechanism, a label to the container, the label including at least one of the type, the amount, a price, and a fill date of the product.

12. The method of claim 11, further comprises:
controlling, by a flow meter, the amount of the product being filled into the container based on the request.

13. The method of claim 11, further comprises:
detecting, by a weight sensor, a weight of the container with the product until the container is filled to the amount in the request for the product.

14. The method of claim 11, wherein filling the container further comprises:
verifying, by the dispensing station and based on a scanned information, whether a size of the container matches the amount in the request for the product.

15. The method of claim 11, wherein the product comprises one of milk, yogurt, ice cream, or smoothie.

16. The method of claim 11, wherein the dispensing kiosk comprises a cabinet to store a plurality of bags of flavorings for supplying one of the flavorings to the product, and wherein the flavorings comprise chocolate flavor, vanilla flavor, strawberry flavor, and banana flavor.

17. The method of claim 11, wherein the dispensing station is configured to fill the product by mixing at least one of ingredients comprising milk, fat, one bag of flavoring, water, ice, and other ingredients.

18. The method of claim 11, further comprising automatically sealing the container with a cap by a sealing module in the dispensing station after the filling is completed.

19. The method of claim 11, further comprising displaying a plurality of status of the dispensing station on a touch screen user interface of the dispensing kiosk.

20. The method of claim 11, further comprising monitoring an overflow of the filling by a moisture sensor in the dispensing station.
